(19) United States
(12) Patent Application Publication
(10) Pub. No.: US 2009/0139400 A1
(43) Pub. Date: Jun. 4, 2009

(54) Diffuser For Exhaust Gas Cleaning Systems

(75) Inventors: Christian Bach, Wangen (CH); Konstantinos Boulouchos, Zurich (CH); Panayotis Dimopoulos, Zurich (CH); Ulrich Vogt, Dubendorf (CH)

Correspondence Address: YI LI, CUSPA TECHNOLOGY LAW ASSOCIATES, 11820 SW 107 AVENUE, MIAMI, FL, 33176, US

(73) Assignees: Eidgenossische Materialprufungs- und Forschung- sanstalt EMPA, Dubendorf (DE); Eidgenossische Technische Hochschule Zurich ETHZ, Zurich (DE)

(21) Appl. No.: 12/085,981

(22) PCT Filed: Dec. 1, 2006
(86) PCT No.: PCT/CH2006/000679

§ 371 Date: Sep. 5, 2008

(30) Foreign Application Priority Data
Dec. 5, 2005 (CH) 1919/05

(51) Int. Cl. B01D 53/94; B01D 53/22; F01N 3/28

(52) U.S. Cl. 95/45; 96/4; 422/177

(57) ABSTRACT

This catalytically active or inactive diffuser is suitable for exhaust gas cleaning systems of internal combustion engines. It consists of a ceramic structure (8) which is obtained from a ceramized polyurethane foam. This ceramic structure (8) can be coated with surface area-increasing and/or oxygen-storing materials and/or noble metals in order to bring about a catalytic action with the gas molecules flowing through it. Because the diffuser is porous in every direction in its interior, a gas and its pressure can spread out equally on all sides through the entire diffuser volume. A virtually homogeneous velocity distribution arises over the entire flow cross section, and increased turbulence is obtained, which leads to more wall contacts of the harmful substance molecules. At the same time, the flow to and through downstream systems over their cross sections with homogeneously mixed exhaust gas including any reactants metered in is more uniform. Overall, it is possible with such a diffuser to produce an exhaust gas cleaning system in a less expensive and more compact manner with the same efficiency.

The invention deals with a diffuser with or without catalytic activity, which is suitable for use in exhaust gas cleaning systems of internal combustion engines, which are considered for diesel engines, petrol engines and gas engines in vehicles.

For such systems, first of all a large working surface has to be placed against the exhaust gas. This consists of a ceramic or metallic body, which can be coated, for example, with aluminium oxide for increasing the surface area. This surface can be coated with noble metals, like, for example, platinum, palladium or rhodium, or perovskite (CaTiO₃) for the achievement of catalytic actions. Such catalytic actions produce harmless nitrogen (N₂) or, reactive nitrogen dioxide (NO₂) from the nitrogen oxides (NOₓ), to convert carbon monoxide (CO) to carbon dioxide (CO₂) and to form carbon dioxide (CO₂) and water (H₂O) out of unburnt or partially burnt hydrocarbons. Liquid or solid reactants are metered into the exhaust gas partially, for example, ammonia solutions, urea solutions or fuel, to produce chemical reactions in the catalysts or to increase the temperature.

The problem of the invention is to produce a diffuser as working surface, by means of which the exhaust gas flow is spread as homogeneously as possible to this first treatment unit of the exhaust gas flow, including metered in reactants, if necessary. With that, firstly the exhaust gas flows through downstream exhaust gas cleaning systems, like particulate filters or catalysts, over the entire cross section and homogenised in composition, independent of the inlet flow, and secondly—in the case of a catalytic coated diffuser—as high a usage as possible of the catalytically working surface in the diffuser itself is achieved. The effect, for example, the conversion or filter efficiency, as well as the function, for example, the continuous regeneration and heat distribution of these downstream systems, should be increased with that. The diffuser should be so designed that the flow resistance created should be as small as possible. Further, this diffuser should take into account that the entire exhaust gas after-treatment unit can be designed compactly, both with regard to reduced space ratios as well as with regard to an economic production and operation in the mass production.

Common systems with catalysts and/or filters are housed in an enlarged silencer compared to the exhaust gas pipe or tail pipe. At first, the incoming exhaust gas flows into an extruded ceramic body, which is, for example, formed in the shape of honeycomb or grid in cross-section, in which the individual honeycombs form very thin cannulae running parallel to each other, through which the gas is lead. The cannulae walls are, for example, coated with aluminium oxide and noble metals or perovskite (CaTiO3). The exhaust gas comes in contact with the cannulae walls in the interior of the many fine cannulae while flowing through, where catalytic reactions take place due to their specific coating. Since the flow resistance of these cannulae is naturally more than that of a free exhaust pipe, the entire cross-section of this ceramic body must be dimensioned much larger than that of the exhaust pipe. But that means that at first the exhaust gas flow must be fanned out from the diameter of the exhaust pipe and only then it can flow against and through the entire cross-section of the ceramic body. Naturally, the gas flows more strongly in the central zone of the ceramic body and the cannulae lying there than in the boundary zones of the ceramic body due to the velocity distribution of the gas flow over the exhaust pipe cross-section. In some cases, the fanning out is eccentric so that the stronger flow zone also lies eccentric. In such cases, the flow is still weaker in the opposite boundary zones. There is no gas exchange between the individual fine cannulae in the interior of the ceramic body but the gas must necessarily flow through these cannulae in the axial direction and exits again afterwards from this at the rear side of the ceramic body. Therefore, no pressure equalisation or material exchange is possible crosswise to the flow direction. A similar inhomogeneous velocity distribution prevails over the cross-section of the ceramic body behind the ceramic body. The velocity is the maximum in the central zone and reduces towards the boundary. The particulate filter connected to the catalytic ceramic body has a similar structure of fine cannulae arranged parallel to each other, in which they are closed in chequered fashion in the front and the respective adjacent ones at the back. The gas flows in into the cannulae that are open in the front and must then necessarily diffuse through the porous cannulae walls into the neighbouring cannulae, from where it exits on the back side of the particulate filter and reaches an exhaust end pipe. The solid materials collected in the particulate filter in the form of soot particles are periodically or continuously burnt, so that the filter is regenerated. Similar flow situations are produced in catalysts, for instance in oxidation-, 3-way- or DeNOx-Catalysts, however without alternately closed cannulae.

The disadvantages arising with such a configuration or arrangement of catalytic flow body and downstream particulate filters or catalysts lies firstly in the necessarily inhomogeneous velocity distribution over the flow cross-section. Therefore, the zones of the catalytic flow body through which the gas flows directly as well as the particulate filter are impinged strongly, which can lead, in comparison to a homogeneous impinging, to reduced retention capacity and to early and prolonged regeneration intervals following each other frequently. Thereby, the ash also gets loaded over the cross-section very inhomogeneously. This applies especially, for example, to inlet geometries of catalysts or particulate filters that cannot be executed optimally due to reasons of space. In addition to that, gaseous, liquid or solid reactants metered into the exhaust gas, for example, ammonia solutions, urea solutions or fuels, cannot mix homogeneously in the exhaust gas flow, for instance, due to short mixing sections or due to inertia, which leads to locally different concentrations of the reactant and consequently to non-optimal systems.

The present invention therefore wishes to create a flow body, which homogenises an inhomogeneous velocity distribution and inhomogeneous composition of the exhaust gas flow and which can also be executed catalytically active in a special embodiment. With that, the gas flow and the composition of the reactant to be metered in should be distributed homogeneously in the flow cross-section. A gas flow with as homogeneous a velocity distribution and homogeneous composition as possible against downstream particulate filters or catalysts should be achieved with that. Besides, this flow body should be cost-effective in production and have as large a working surface as possible for the gas flowing through.

This problem is solved by a diffuser for exhaust gas cleaning systems, consisting of a foam- or sponge-like or three dimensional grid-type ceramic structure through which a gas can flow through in all directions macroscopically. The diffuser can be catalytic coated according to the embodiment and is then catalytically active or it is not catalytically active, if it is not especially coated.

In the drawings, the structure of an exhaust gas cleaning system with such a catalytically active diffuser is compared with a system with a usual catalytic flow body. In addition to that, its structure and its action is explained.

It is shown in:

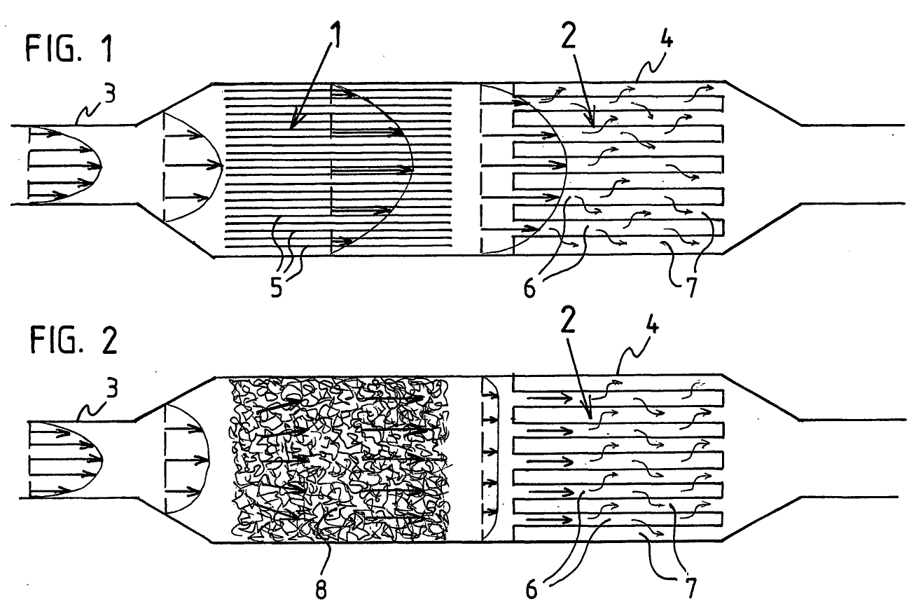

FIG. 1: a schematic representation of a usual structure of an exhaust gas cleaning system with a catalytic flow body with honeycomb-shaped cross-section and downstream particulate filter;

FIG. 2: a schematic representation of the structure of an exhaust gas cleaning system with a diffuser of the present invention in the form of a flow body made from a ceramic polyurethane foam and downstream particle filter.

Investigations of the applicant show that ceramic foam- or sponge-type structures, namely porous in all directions, can deflect flows of gases and diffuse to distribute and make generally homogeneous, independent of the inlet geometry. It is important that these structures are gas-permeable in all directions. In a sequential arrangement of four such 20 mm deep structures in a flow channel with square cross-section of 70×70 mm, an essentially homogeneous flow could be created from a strongly inhomogeneous flow, that is, such a one with very different velocities over the square-sectional area of the flow channel. In order to ensure for the test an inhomogeneous flow at the entry, the gases were supplied to a pipe in the flow channel, which was arranged at a 45° angle to this flow channel. From the test carried out, the main conclusion that could be arrived at was that the velocity profiles following the flow through this type of structure are strongly modified, both the velocity profiles for the axial as well as for the transversal velocities of flowing gas molecules. Such results were achieved even for entirely different flow strengths (flowing mass per unit time) for the mentioned test arrangement at approximately 50 kg/h up to 400 kg/h.

Another aspect is the mixing and turbulence of the gas, especially at right angle to the flow axis, which arises by the flowing through of such structures. This result is meaningful for the thorough mixing of harmful substances in the exhaust gas before this arrives at catalysts and collectors or particulate filters, where the particles are held back and/or chemical reactions take place. Only thoroughly mixed exhaust gases ensure that the catalyst and collector surfaces are uniformly loaded. It has been demonstrated that these ceramic structures, porous in all directions, produce a strong turbulence in the gases after their exit from the structures. It can be concluded that the turbulences are actually formed in the interior of the structures. The turbulence is the strongest directly at the exit from the structure and then weakens in the free flow channel progressively as expected. The strong turbulence in the interior of the structure is very beneficial for an efficient interaction with the catalytic surface of the structure. Correspondingly, the rate of the converted harmful substances for the flowing through of such catalytic structure body is essentially increased in comparison to the flowing through a channel catalyst. It is particularly meaningful if one considers that the flow through a regular monolithic body like that of the previous ceramic flow bodies is to a large extent laminar, with higher Reynolds number. The kinetic energy density is compared with the frictional loss density with this dimensionless number. The velocity gradient square to the flow direction is estimated through the typical value of the velocity and the characteristic length or dimension of the system, for example, of the diameter of a flow pipe. The Reynolds number is consequently a stability criterion for laminar flows. Limit values for different flows can be found empirically, the so-called critical Reynolds numbers.

The flow is laminar below the critical value and turbulent above it. The geometrical form of the object plays a large role for the formation of turbulences. It was now established that, immediately after the flowing through the ceramic, foam or sponge type structures, porous in all directions, the intensity of turbulence of the outflows out of the structure is increased very much in the local flow field. Therefore, everything is positive for the achievement of catalytic actions—however, the question remains to be answered as to how such ceramic, foam or sponge type structures, porous in all directions, affect the fall of pressure in the flow gas. A large pressure drop is not desirable, since large losses are connected with it for pushing out the exhaust gas. The fuel consumption of the concerned engine increases markedly with that. The pore size and the porosity was so selected on the basis of computer estimations that the pressure drop is not more than for the flow through a regular monolithic flow body.

In all, such ceramic, foam- or sponge-type structures, porous in all directions, show following properties as flow body for flow throughs in comparison to the usual flow bodies:
A homogeneous velocity profile in the flowing gas after the flow body;
Increased turbulence and swirling of the gas after passing the flow body, that is, behind the flow body;
The gas flow in a ceramic, foam- or sponge-type flow body porous in all directions is essentially more turbulent than that in a monolithic flow body with straight flow channels;
The pressure drop after flowing through a ceramic, foam- or sponge-type flow body, porous in all directions, is more than for a monolithic flow body with straight flow channels, but however not very much more that this would also only approximately balance the other advantages. The optimisation potential of a ceramic, foam- or sponge-type flow body, porous in all directions, promises a clearly still reducible pressure drop.

Therefore, the use of a catalytically active, that is a catalytic coated, or even only a catalytically not active, that is a catalytic uncoated, diffuser for exhaust gas cleaning systems, which consists of such a foam- or sponge-type ceramic structure, porous on all sides, provides significant advantages for exhaust gas cleaning systems. Such open-cellular foam- or sponge-type ceramics are, for example, produced according to the Schwartzwalder method, described in the U.S. Pat. No. 3,090,094 of year 1963. Therein, for example, recirculated polymer-foam materials are impregnated with a ceramic suspension and pressed out via squeeze rolling or similar methods, and the formed parts are dried afterwards. The pore size of the ceramic foam is predetermined by the polymer foam and lies, for example, between 5 and 50 ppi, which corresponds to approximately 5000 to 500 μm. The polymer foam is thermally reduced at a temperature of, e.g., 300-600° C. during the subsequent heat treatment. Thereafter the sintering of the porous ceramic body follows, in which the sintering temperature can lie between 1000-2200° C. according to the material. Through one or more subsequent infiltrations and by means of coating of the porous ceramic body, its strength can be clearly increased. There is also the possibility to infiltrate the ceramic foam with a catalytically active material or to coat and to subject this layer to a heat treatment. One speaks in professional circles regularly of ceramic foams although these are permeable on all sides and thus resemble a sponge structure rather than a foam structure.

FIG. 1 shows in schematic representation of a catalyst 1 with particulate filter 2, incorporated in an exhaust pipe 3 of an internal combustion engine. It is housed in an exhaust silencer 4, which has a larger diameter than the supplying exhaust pipe 3. The catalyst 1 is arranged in the first zone of the exhaust silencer 4, to which the particulate filter 2 is connected. The function of the catalyst 1 is to convert the incoming harmful materials permanently in a smallest possible space under a smallest possible pressure drop. Here, the harmful substances react chemically on the catalyst surface. Until now an extruded ceramic body is used for this, which was coated, e.g., with aluminium oxide with a catalytically active noble metal for the enlargement of its surface in a single or multiple layer process. Platinum, palladium, rhodium or another suitable noble metal as well as perovskite (CaTiO3) is used for this noble metal coating. Such an extruded catalyst body consists of a very large number of straight flow channels 5 lying parallel to each other. The inner wall of each flow channel 5 forms the surface, with which the harmful material molecules flowing through can catalytically act. Once in the catalyst body, the gas that has flown in is entrapped in the fine flow channels 5 and can still flow along this channel 5. Cross flows are not possible.

It is clear that in the schema represented, a velocity distribution is created before the catalyst 1. A typical distribution curve in the exhaust pipe 1 is plotted qualitatively for this with some velocity vectors. Therefore, the zone of the catalyst 1 against which the gas flows directly is always impinged with gas molecules at much higher velocity than the outer zones. The gas flows very weakly through the boundaries of the catalyst body. A typical distribution curve of the axial velocities is plotted qualitatively over the catalyst 1, in which the velocities are plotted as vectors. Therefore, the different surfaces of this catalyst 1 are impinged with gas molecules quite differently: Where the flow velocities are high, more gas molecules come along per unit time and can react there catalytically with the catalyst surface. The catalytic action therefore deteriorates more rapidly in the central zone than in the boundary zones and when the catalyst 1 is consumed, the boundary zones are still intact. The gases experience only weak turbulences in the interior of the catalyst 1, thus the superimposed axial velocity is modified only little. Also behind the catalyst 1, the distribution curve of the velocities has much higher velocities in the centre than in the rim of the exhaust silencer 4. This produces inhomogeneous velocity distribution curve, which is likewise plotted qualitatively, and acts disadvantageously on the operation of the downstream exhaust gas after-treatment systems, such as, e.g., particulate filters or further catalysts 2. As a rule, these treatment systems consist of a number of porous flow channels 6,7 lying adjacent to each other, in which, for the particulate filter 2, half of these channels 6,7 are closed behind in chequered fashion alternately and the other half 7 are closed in the front of the particulate filter in chequered fashion. Hence all flow channels 6 open in the front, against which the gases flow, work as pockets. The gases must diffuse through the porous walls of these pockets into the neighbouring flow channels 7 so that the gases then exit inevitably behind from the open end of these flow channels 7 and are expelled to the outside through the exhaust pipe. Now, if the gases, e.g., at the inlet cross-section of the particulate filter 2 emerge with entirely different velocities, that is again with higher velocities in the directly flown in zones and reduced velocities in the rim, it is immediately clear that the flow channels against which the gases flow directly must hold back many more particles than the flow channels 6 lying at the rim. The non-uniform impact, e.g., of the particulate filter 2 is very disadvantageous. When the central flow channels already reach the end of their collection capacity, the outer ones can still be almost condensation-free. The regeneration of a highly non-uniformly impinged particulate filter has few disadvantages: Non-uniform temperature distribution, high local temperature peaks and non-uniform ash loading. These disadvantages not only reduce the effectiveness of the particulate filter but also reduce its life considerably.

In order to achieve an efficient and compact homogenisation, catalytic conversion or filter-like separation of the harmful materials, the velocities of the gas molecules must be urgently equalised over the cross-section of the exhaust gas pipe 1 or exhaust gas silencer 4. A foam- or sponge-type ceramic structure porous in all directions proves to be very effective for this objective. Such an arrangement is shown in FIG. 2. The previous monolithic ceramic body, which consists of flow-cannulae lying merely together, running parallel to each other with gas-tight walls, was replaced by a foam- or sponge-type ceramic structure 8. This ceramic structure 8 thus forms a three dimensional, closely interwoven grid or network and is permeable in all directions macroscopically seen. Due to this fact and since a gas spreads always to all sides and takes up the available space, a good diffusion is achieved. Simultaneously, the gas swirls very efficiently and the superimposed axial velocities are equalised with each other, as is qualitatively indicated in the schematic velocity distribution curve. This ceramic structure thus works excellently as diffuser and releases the gas flowing through uniformly over the entire exhaust gas silencer cross-section into downstream exhaust gas after-treatment systems like catalyst, DeNox-system or particulate filter 2. In order to achieve a catalytic action of the ceramic structure 8, this is, e.g., coated with one or more surface area-increasing, oxygen-storing materials and/or catalytically effective materials. Particularly, such a foam- or sponge-type or three dimensional grid-type, macroscopically permeable in all directions ceramic structure 8 can be produced by immersing a polyurethane foam in a ceramic slurry. The polyurethane foam soaked with ceramic coming out of the ceramic slurry is subsequently dried and the polyurethane foam is afterwards burnt out from the structure arisen. What remains is a three dimensional foam- or sponge-type or grid- to network-type structure body. This is permeable by a gas in any direction in the macroscopic sense. This hard structure body can be coated with catalytically active material at the same time or afterwards in a further process. Thus its entire internal surfaces, that is, all internal bars or network bridges or internal foam- or sponge-structures, are coated with the catalytic material. Especially, this coating may contain surface area-increasing and/or oxygen-storing materials, such as noble metal or perovskite (CaTiO3) materials. Platinum, palladium and rhodium are suitable as noble metal for the treatment of exhaust gases of internal combustion engines. A ceramic body produced and coated in such a way can be produced in any geometrical form, while the polyurethane foam is produced in the desired geometric form or tailored to such a one beforehand, so that it can be incorporated as diffuser and simultaneously as catalyst in an exhaust gas pipe or in the exhaust gas silencer of an exhaust gas pipe instead of the previous ceramic body. It produces in catalytic coated or uncoated embodiment a homogeneous fanning out of the incoming inhomogeneous exhaust gas stream in the operation and treats the same, in the case of catalytic coated embodiment, simultaneously catalytically, and also, uniformly.

1. Diffuser for exhaust gas cleaning systems consisting of a foam- or sponge-type or three dimensional grid-type ceramic structure (8) macroscopically permeable in all directions.

2. Diffuser for exhaust gas cleaning systems according to claim 1, characterised by the fact that, it is produced by immersing a polyurethane foam in a ceramic slurry and burning out the polyurethane foam afterwards.

3. Diffuser for exhaust gas cleaning systems according to claim 1, characterised by the fact that, it is catalytically active for exhaust gases, while it has a catalytically active coating.

4. Diffuser for exhaust gas cleaning systems according to claim 1, characterised by the fact that, it is catalytically active for exhaust gases, while it has a catalytically active coating provided in a dipping method.

5. Diffuser for exhaust gas cleaning systems according to claim 1, characterised by the fact that, it is coated with a surface area-increasing and/or oxygen-storing and/or a catalytically active material.

6. Diffuser for exhaust gas cleaning systems according to claim 1, characterised by the fact that, it consists of a ceramic structure (8), which is coated with surface area-increasing or oxygen-storing materials, noble metals or with perovskite (CaTiO3).

7. Use of a diffuser for exhaust gas cleaning systems according to claim 1 for the diffusion that is, for the homogeneous fanning of an exhaust gas stream.

8. Use of a diffuser for exhaust gas cleaning systems according to claim 3 for the diffusion, that is, for the homogeneous fanning of an exhaust gas stream and for the catalytic treatment of the same.

9. Use of a diffuser according to claim 1 for use as homogeniser instead of or before an oxidation- or three-way catalyst, as part of a or before a DeNOx system or before a particulate filter.
